(19) United States
(12) Patent Application Publication
(10) Pub. No.: US 2010/0260249 A1
(43) Pub. Date: Oct. 14, 2010

(54) METHOD OF EXAMINING ELIGIBILITY OF A MODULATION AND CODING SCHEME FOR A COMMUNICATIONS SYSTEM

(76) Inventors: Yung-Szu Tu, Taipei County (TW); Jiunn-Tsair Chen, Hsinchu County (TW); Chun-Hsien Wen, Hsinchu County (TW); Cheng-Hsuan Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/554,993

(22) Filed: Sep. 8, 2009

(30) Foreign Application Priority Data
Apr. 10, 2009 (TW) 098112028

(51) Int. Cl. H04Q 1/20

(52) U.S. Cl. 375/227

(57) ABSTRACT

A method of examining the eligibility of a modulation and coding scheme includes determining a range of pseudo signal-to-noise ratio (pseudo-SNR) corresponding to a range of packet correct rate (PCR) acceptable for a transmitter, obtaining a first score of a positive acknowledgement (ACK) and a second score of a negative acknowledgement (NACK) according to the range of pseudo-SNR and the range of PCR, applying weighting to a score of a response message, which is one of an ACK message and a NACK message, and a pseudo-SNR corresponding to an immediately preceding response message when receiving the response message, for generating a pseudo-SNR corresponding to the response message, and examining the eligibility of a modulation and coding scheme in use according to the pseudo-SNR corresponding to the response message.

### BACKGROUND OF THE INVENTION

1. Field of the Invention

The present invention relates to a method of examining the eligibility of a modulation and coding scheme for a transmitter of a communications system, and more particularly, to a method for obtaining channel condition according to a response message corresponding to a transmitted packet and examining the eligibility of a modulation and coding scheme in use accordingly.

2. Description of the Prior Art

To achieve expected communication functions and quality in a wireless communications system, different modulation and coding schemes, having different modulation techniques, coding rates, etc. for different data rates, are defined in associated specifications, with each different modulation and coding scheme distinguished by an index. The wireless communications system can select an appropriate modulation and coding scheme from current available modulation and coding schemes, for achieving the expected throughput.

In the wireless communications system, a channel is not ideal, and transmission failure occurs due to many factors, such as multipath transmission, noise, and interference caused by electronic equipment. When a transmitter has no idea about the channel condition, the transmitter can only estimate the channel condition through transmission results of transmitted packets, i.e. positive acknowledgements (ACKs) or negative acknowledgements (NACKs) that is transmitted by a receiver of the wireless communications system, and reselect a modulation and coding scheme for a higher data rate when the channel condition is good, or for a lower data rate when the channel condition is getting worse. That is so-called rate adaptation.

In order to achieve the rate adaptation, several methods, such as an Onoe algorithm, an adaptive multi rate retry (AMRR) algorithm, a multiband Atheros Driver for WiFi (Madwifi) algorithm, and a robust rate adaptation algorithm (RRAA), are adopted. The Onoe algorithm uses a specific data rate to transmit packets for a period, and increases the data rate to a higher level when a packet error rate in the period is lower than a threshold, or decreases the data rate to a lower level when the packet error rate is higher than the threshold. The AMRR and Madwifi algorithms use probe packets and two packet correct rate thresholds to determine whether to step up or step down the data rate. The RRAA algorithm determines the data rate according to the received ACK and the packet correct rate. When the transmitter uses a modulation and coding scheme with the most optimal throughput, the packet correct rate will be within a predetermined range.

From the above, whether the packet correct rate is within the predetermined range is determined by calculating the packet correct rate. To obtain the packet correct rate, the number of transmitted packets and the number of packets that are successfully received by the receiver are counted for a predetermined time interval. Thus, the packet correct rate is the number of packets successfully received divided by the number of transmitted packets. There are two serious drawbacks in the conventional rate adaptation methods, one is that the transmitter can only know the packet correct rate periodically, not in real-time, and the other is that system complexity of the transmitter increases because the transmitter requires performing division to obtain the packet correct rate. When channel condition changes dramatically, the packet correct rate may become very high or very low during the predetermined time interval in which the transmitter has to count packets. As a result, the transmitter cannot adjust the modulation and coding scheme as soon as possible to have an appropriate data rate in response to the varying packet correct rate.

### SUMMARY OF THE INVENTION

It is therefore a primary objective of the claimed invention to provide a method of examining the eligibility of a modulation and coding scheme for a communications system.

The present invention discloses a method of examining the eligibility of a modulation and coding scheme comprising determining a range of pseudo signal-to-noise ratio (pseudo-SNR) corresponding to a range of packet correct rate (PCR) acceptable for the transmitter, obtaining a first score of a positive acknowledgement (ACK) and a second score of a negative acknowledgement (NACK) according to the range of pseudo-SNR and the range of PCR, applying weighting to a score of a response message, which is one of an ACK message and a NACK message, and a pseudo-SNR corresponding to an immediately preceding response message when receiving the response message, for generating a pseudo-SNR corresponding to the response message, and examining the eligibility of a modulation and coding scheme in use according to the pseudo-SNR corresponding to the response message.

The present invention further discloses a method of examining the eligibility of a modulation and coding scheme comprising determining a range of pseudo-SNR corresponding to a range of PCR acceptable for the transmitter, obtaining a first score of an ACK and a second score of a NACK according to the range of pseudo-SNR and the range of PCR, generating a pseudo-SNR corresponding to a response message, which is one of an ACK message and a NACK message, according to the number of accumulated received ACK messages, the number of accumulated received NACK messages, the first score, and the second score when receiving the response message, and examining the eligibility of a modulation and coding scheme in use according to the pseudo-SNR corresponding to the response message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process according to an embodiment of the present invention.

FIG. 2 is a diagram of packet correct rate versus signal-to-noise rate measured by an IEEE 802.11n transmitter using the process in FIG. 1.

FIG. 3 is a flowchart of a process according to an embodiment of the present invention.

### DETAILED DESCRIPTION

Signal-to-noise ratio (SNR) indicates quality of a communication channel in a wireless communications system, which is the ratio of a signal power to a noise power corrupting the signal. The present invention explores a relationship between a packet correct rate (PCR) and a corresponding SNR, and relates the PCR to a relative indication of channel condition, defined as a pseudo-SNR, which is not a real SNR. The present invention examines the eligibility of a modulation and coding scheme in use according to the pseudo-SNR.

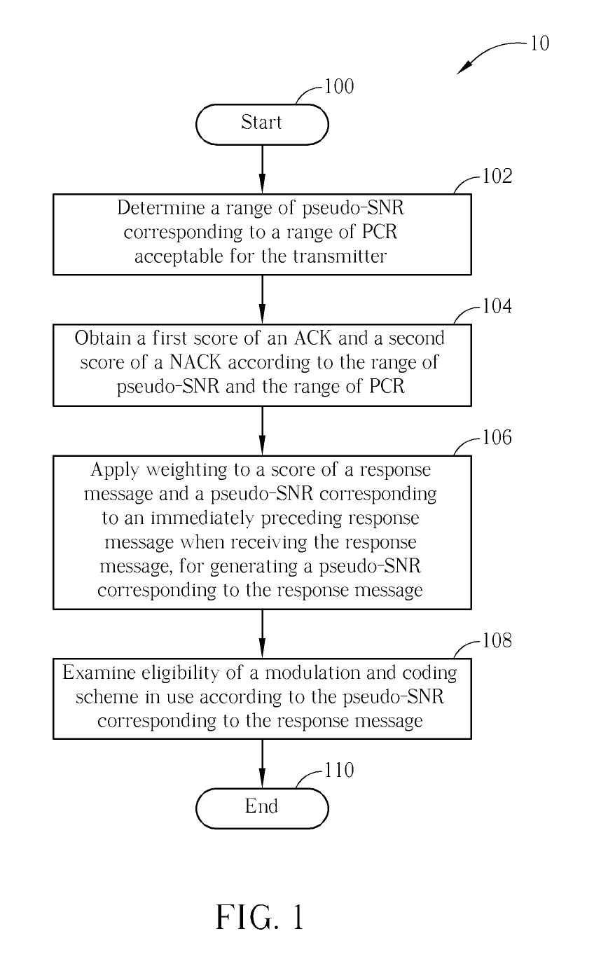

Please refer to FIG. 1, which is a flowchart of a process 10 according to an embodiment of the present invention. The process 10 is utilized in a transmitter of a wireless communications system for examining the eligibility of a modulation and coding scheme. The process 10 comprises the following steps:

Step 100: Start.

Step 102: Determine a range of pseudo-SNR corresponding to a range of PCR acceptable for the transmitter.

Step 104: Obtain a first score of a positive acknowledgement (ACK) and a second score of a negative acknowledgement (NACK) according to the range of pseudo-SNR and the range of PCR.

Step 106: Apply weighting to a score of a response message and a pseudo-SNR corresponding to an immediately preceding response message when receiving the response message, for generating a pseudo-SNR corresponding to the response message.

Step 108: Examine the eligibility of a modulation and coding scheme in use according to the pseudo-SNR corresponding to the response message.

Step 110: End.

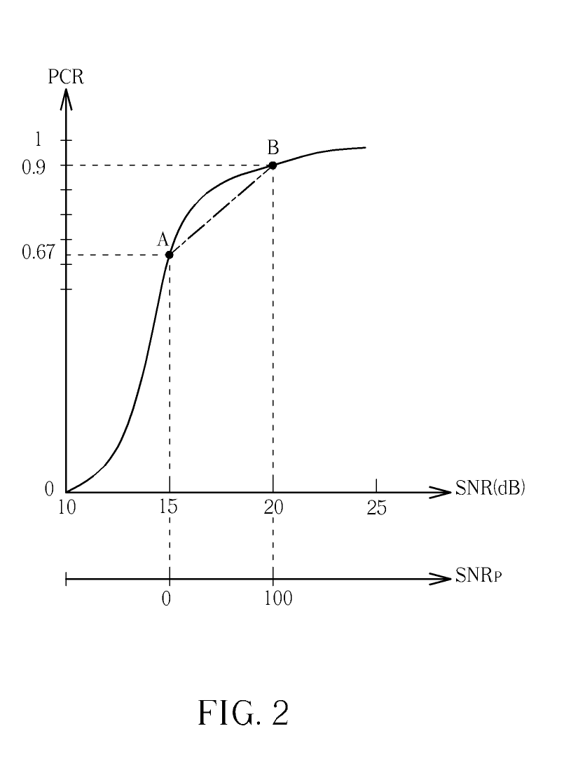

Before the process 10 is introduced, please refer to FIG. 2. FIG. 2 is a diagram of PCR versus SNR measured by an IEEE 802.11n transmitter using the process 10 based on a predetermined modulation and coding scheme. As shown in FIG. 2, the acceptable PCR ranges from 0.67 to 0.9, where 0.67 is a lower bound of PCR and corresponds to a SNR 15 dB, and 0.9 is an upper bound of PCR and corresponds to a SNR 20 dB. In other words, when the transmitter uses the predetermined modulation and coding scheme, the estimated SNR should be within a range from 15 dB to 20 dB to have a PCR within the acceptable range. The SNR range of 15 dB-20 dB is regarded as the acceptable range of SNR. The transmitter may obtain different acceptable range of PCR when the transmitter changes the modulation and coding scheme. When the channel condition is good, the transmitter may obtain a PCR better than the upper bound 0.9; in this situation, the data rate shall be increased by reselecting a modulation and coding scheme. Otherwise, when the channel condition is getting worse, the transmitter may obtain a PCR lower than the lower bound 0.67, and the transmitter has to decrease the data rate to maintain the throughput. Briefly, the transmitter reselects a modulation and coding scheme to maintain the throughput when the PCR is out of the acceptable range.

Note that, in FIG. 2, there is another axis below the SNR axis, a pseudo-SNR axis, which is defined by the present invention. A pseudo-SNR is not equal to the real SNR, and is an indication of channel condition, presented as a score. The pseudo-SNR is a relative value, not an absolute value. The range of pseudo-SNR and its lower and upper bounds can be defined in any scale. Take FIG. 2 as an example, the lower bound of acceptable PCR corresponds to a pseudo-SNR 0, and the upper bound of acceptable PCR corresponds to a pseudo-SNR 100. In other words, a range of pseudo-SNR from 0 to 100 corresponds to the acceptable range of PCR. As shown in FIG. 2, a straight line is formed by connecting two points A and B which corresponds to the lower and upper bound of acceptable PCR. This straight line is expressed as

S_ACK×PCR+S_NACK×(1−PCR)=SNR_{P}, (1)

where PCR is the packet correct rate, SNR_{P} is the pseudo-SNR, S_ACK is a positive score which increases the pseudo-SNR when the transmitter receives an ACK, and S_NACK is a negative score which decreases the pseudo-SNR when the transmitter receives a NACK. An ACK or a NACK is a response message sent from a receiver in the wireless communications system to inform the transmitter that a packet is successfully received or not. When the transmitter receives an ACK, it indicates that the channel condition is good so that the receiver successfully receives the packet. When the PCR of the transmitter increases because of receiving an ACK, the positive score S_ACK has more influence on the pseudo-SNR, thus the pseudo-SNR increases. In addition, when the transmitter receives a NACK, it indicates that the channel condition is getting worse and the receiver does not receive the packet successfully. When the PCR of the transmitter decreases because of receiving a NACK, the negative score S_NACK has more influence on the pseudo-SNR, thus the pseudo-SNR decreases.

The process 10 is described as follows. According to Step 102, the transmitter determines a range of pseudo-SNR from a lower bound SNR_{P}_{_{—}}_{L} to an upper bound SNR_{P}_{_{—}}_{U}, corresponding to an acceptable range of PCR from a lower bound PCR_{L} to an upper bound PCR_{U}. As can be seen in FIG. 2, the range of pseudo-SNR from 0 to 100 corresponds to the acceptable range of PCR from 0.67 to 0.9. Note that, the acceptable range of PCR is already known before the process 10 is performed. Step 104 is expressed by equation (1). The transmitter obtains a first score of an ACK, S_ACK, and a second score of a NACK, S_NACK, according to the range of pseudo-SNR and the acceptable range of PCR. That is, the two unknown scores S_ACK and S_NACK are solved by equation (1) given bound values including PCR_{L}, PCR_{U}, SNR_{P}_{_{—}}_{L}, and SNR_{P}_{_{—}}_{U} as

S_ACK×PCR_{L}+S_NACK×(1−PCR_{L})=SNR_{P}_{_{—}}_{L}, and (2)

S_ACK×PCR_{U}+S_NACK×(1−PCR_{U})=SNR_{P}_{_{—}}_{U}. (3)

As shown in FIG. 2, equations (2) and (3) are replaced as

S_ACK×0.67+S_NACK×(1−0.67)=0, and (4)

S_ACK×0.9+S_NACK×(1−0.9)=100. (5)

By equations (4) and (5), the scores S_ACK and S_NACK are solved:

$$[ \begin{matrix}S\_ACK \\ S\_NACK\end{matrix} ] = {[ \begin{matrix}0.67 & 1 - 0.67 \\ 0.9 & 1 - 0.9\end{matrix} ]}^{- 1} [ \begin{matrix}0 \\ 100\end{matrix} ] . \qquad ( 6 )$$

According to Step 106, when the transmitter receives a response message, which may be an ACK or a NACK, the transmitter applies weighting to a score S_NEW of the response message and a pseudo-SNR Old_SNR_{P} corresponding to an immediately preceding response message, which indicates the channel condition in the past, to generate a pseudo-SNR Current_SNR_{P} corresponding the response message currently received. Step 106 is expressed as

Current_SNR_{P}=Old_SNR_{P}×w+S_NEW×(1−w), (7)

where S_NEW may be the score S_ACK or S_NACK defined previously, which depends on what the response message is. If the response message is an ACK, S_NEW is equal to S_ACK; if the response message is a NACK, or if the transmitter does not receive any ACK for a predetermined time interval, S_NEW is equal to S_NACK. A weighting value w is given by the transmitter to distribute the pseudo-SNR Old_SNR_{P} and the score S_NEW. According to equation (7), a larger weighting value means that the transmitter relies on the pseudo-SNR Old_SNR_{P} more than the response currently received when determining the pseudo-SNR corresponding to current channel condition, whereas a smaller weighting value indicates that the transmitter relies on the response message currently received more than the channel condition in the past when determining the pseudo-SNR corresponding to the current channel condition.

After the pseudo-SNR Current_SNR_{P} is generated, the transmitter examines the eligibility of the modulation and coding scheme in use according to the pseudo-SNR Current_SNR_{P}, to know whether the modulation and coding scheme is eligible. The pseudo-SNR Current_SNR_{P} within the acceptable range of SNR_{P}_{_{—}}_{L}-SNR_{P}_{_{—}}_{U} indicates that the modulation and coding scheme is qualified and can be used continuously, whereas the pseudo-SNR Current_SNR_{P} out of the acceptable range of SNR_{P}_{_{—}}_{L}-SNR_{P}_{_{—}}_{U} indicates that the modulation and coding scheme is disqualified and should be updated for maintaining the throughput. Briefly, when the transmitter receives a response message, the transmitter generates a pseudo-SNR and determines whether the pseudo-SNR is within an acceptable range so as to examine the eligibility of the modulation and coding scheme. As shown in FIG. 2, when the pseudo-SNR is more than 100, it indicates that the channel condition is good, and the transmitter has to reselect a modulation and coding scheme of a higher data rate. When the pseudo-SNR is less than 0, it indicates that the channel condition is bad, and the transmitter has to reselect a modulation and coding scheme of a lower data rate. When the pseudo-SNR is within the range of 0-100, it indicates that the modulation and coding scheme in use leads to an acceptable throughput, and the transmitter does not require reselecting a new modulation and coding scheme.

In the prior art, the transmitter has to wait for a predetermined time interval to count the number of received ACKs to obtain the packet correct rate, in order to know the eligibility of the modulation and coding scheme. Therefore, the rate adaptation is performed periodically, not in real-time, and the transmitter cannot adjust data rate sensitively to deal with the channel condition changing dramatically. The present invention defines the pseudo-SNR to represent the channel condition, and replaces the packet correct rate with the pseudo-SNR to examine the eligibility of the modulation and coding scheme. Each time the transmitter receives a response message, the pseudo-SNR is generated without calculating the real packet correct rate, and the transmitter can determine whether the modulation and coding scheme is qualified in real-time. Compared with the prior art, the present invention examines the eligibility of the modulation and coding scheme more efficiently.

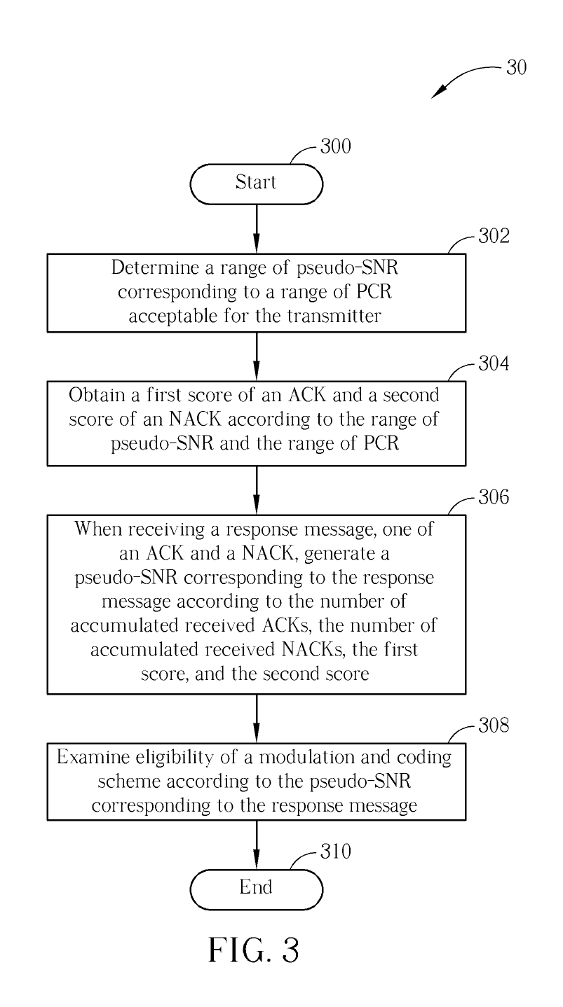

Please refer to FIG. 3, which is a flowchart of a process 30 according to an embodiment of the present invention. The process 30 is also utilized in the transmitter for examining the eligibility of a modulation and coding scheme. The process 30 comprises the following steps:

Step 300: Start.

Step 302: Determine a range of pseudo-SNR corresponding to a range of PCR acceptable for the transmitter.

Step 304: Obtain a first score of an ACK and a second score of an NACK according to the range of pseudo-SNR and the range of PCR.

Step 306: When receiving a response message, one of an ACK and a NACK, generate a pseudo-SNR corresponding to the response message according to the number of accumulated received ACKs, the number of accumulated received NACKs, the first score, and the second score.

Step 308: Examine the eligibility of a modulation and coding scheme according to the pseudo-SNR corresponding to the response message.

Step 310: End.

Step 302 and Step 304 are similar to Step 102 and Step 104 of the process 10, for obtaining the score S_ACK corresponding to a received ACK and the score S_NACK corresponding to a received NACK, which are not repeated herein. According to Step 306, when the transmitter receives a response message, the transmitter generates a pseudo-SNR SNR_{P} corresponding to the received response message according to the number of accumulated received ACKs N_{ACK}, the number of accumulated received NACKs N_{NACK}, the first score S_ACK, and the second score S_NACK. Step 306 is expressed as

$$( \frac{{N}_{ACK}}{{N}_{TOTAL}} ) \times S\_ACK + ( \frac{{N}_{NACK}}{{N}_{TOTAL}} ) \times S\_NACK = {SNR}_{P} , \qquad ( 8 )$$

where N_{TOTAL} is the number of accumulated received response messages including ACKs and NACKs, that is, N_{TOTAL}=N_{ACK}+N_{NACK}. Note that, equation (8) is equivalent to equation (1), wherein NACK/N_{TOTAL} is the PCR and N_{NACK}/N_{TOTAL} is the packet error rate equal to (1-PCR). According to Step 306, the packet correct rate is calculated each time when the transmitter receives a response message. According to Step 308, which is similar to Step 108 of the process 10, the transmitter determines whether the modulation and coding scheme is eligible according to the pseudo-SNR. Through the process 30, each time the transmitter receives a response message, the transmitter generates a pseudo-SNR and then determines whether the pseudo-SNR is in an acceptable range. The process 30 improves the drawback that the transmitter can only adjust the modulation and coding scheme periodically. However, the transmitter requires calculating the packet correct rate in the process 30 and thus the system complexity is still high. The process 10 simplifies the system complexity better than the process 30.

In conclusion, the present invention uses the pseudo-SNR as an indication of channel condition, obtains the pseudo-SNR each time when the transmitter receives a response message, and determines whether a modulation and coding scheme in use is eligible. Compared with the prior art, the present invention does not require waiting for calculating the packet correct rate, so that the system complexity is reduced and the data rate can be adjusted more sensitively.

Those skilled in the art will readily observe that numerous modifications and alterations of the device and method may be made while retaining the teachings of the invention.

What is claimed is:

1. A method of examining an eligibility of a modulation and coding scheme comprising:
determining a range of pseudo signal-to-noise ratio (pseudo-SNR) corresponding to a range of acceptable packet correct rate (PCR);
obtaining a first score of a positive acknowledgement (ACK) and a second score of a negative acknowledgement (NACK) according to the range of pseudo-SNR and the range of PCR;
applying weighting to a score of a response message, which is one of an ACK message and a NACK message, and a pseudo-SNR corresponding to a preceding response message when receiving the response message, for generating a pseudo-SNR corresponding to the response message; and
examining an eligibility of a modulation and coding scheme according to the pseudo-SNR corresponding to the response message.

2. The method of claim 1, wherein the step of obtaining the first score and the second score according to the range of pseudo-SNR and the range of PCR is obtaining the first score and the second score according to a lower bound and an upper bound of the range of pseudo-SNR and a lower bound and an upper bound of the range of PCR, which is expressed by equations as
S_ACK×PCR_{L}+S_NACK×(1−PCR_{L})=SNR_{P}_{_{—}}_{L}, and
S_ACK×PCR_{U}+S_NACK×(1−PCR_{U})=SNR_{P}_{_{—}}_{U},
where SNR_{P}_{_{—}}_{L} is the lower bound of the range of pseudo-SNR, SNR_{P}_{_{—}}_{U} is the upper bound of the range of pseudo-SNR, PCR_{L} is the lower bound of the range of PCR, PCR_{U} is the upper bound of the range of PCR, S_ACK is the first score, and S_NACK is the second score.

3. The method of claim 1, wherein the step of applying weighting to the score of the response message and the pseudo-SNR corresponding to the immediately preceding response message when receiving the response message for generating the pseudo-SNR corresponding to the response message is represented by
Current_SNR_{P}=Old_SNR_{P}×w+S_NEW×(1−w),
where Old_SNR_{P} is the pseudo-SNR corresponding to the immediately preceding response message, Current_SNR_{P} is the pseudo-SNR corresponding to the response message, S_NEW is the score of the response message, and w is a weighting value.

4. The method of claim 1, wherein when the response message is the ACK message, the score of the response message is the first score.

5. The method of claim 1, wherein when the response message is the NACK message, the score of the response message is the second score.

6. The method of claim 1, wherein the step of examining the eligibility of the modulation and coding scheme in use according to the pseudo-SNR corresponding to the response message comprises:
determining that the modulation and coding scheme in use can be used continuously when the pseudo-SNR corresponding to the response message is within the range of pseudo-SNR.

7. The method of claim 1, wherein the step of examining the eligibility of the modulation and coding scheme in use according to the pseudo-SNR corresponding to the response message comprises:
determining to update the modulation and coding scheme when the pseudo-SNR corresponding to the response message is out of the range of pseudo-SNR.

8. The method of claim 1, wherein the pseudo-SNR is an indication of channel condition.

9. A method of examining an eligibility of a modulation and coding scheme comprising:
determining a range of pseudo signal-to-noise ratio (pseudo-SNR) corresponding to a range of acceptable packet correct rate (PCR);
obtaining a first score of a positive acknowledgement (ACK) and a second score of a negative acknowledgement (NACK) according to the range of pseudo-SNR and the range of PCR;
generating a pseudo-SNR corresponding to a response message, which is one of an ACK message and a NACK message, according to the number of accumulated received ACK messages, the number of accumulated received NACK messages, the first score, and the second score when receiving the response message; and
examining an eligibility of a modulation and coding scheme in use according to the pseudo-SNR corresponding to the response message.

10. The method of claim 9, wherein the step of obtaining the first score and the second score according to the range of pseudo-SNR and the range of PCR is obtaining the first score and the second score according to a lower bound and an upper bound of the range of pseudo-SNR and a lower bound and an upper bound of the range of PCR, which is expressed by equations as
S_ACK×PCR_{L}+S_NACK×(1−PCR_{L})=SNR_{P}_{_{—}}_{L}, and
S_ACK×PCR_{U}+S_NACK×(1−PCR_{U})=SNR_{P}_{_{—}}_{U},
where SNR_{P}_{_{—}}_{L} is the lower bound of the range of pseudo-SNR, SNR_{P}_{_{—}}_{U} is the upper bound of the range of pseudo-SNR, PCR_{L} is the lower bound of the range of PCR, PCR_{U} is the upper bound of the range of PCR, S_ACK is the first score, and S_NACK is the second score.

11. The method of claim 9, wherein the step of generating the pseudo-SNR corresponding to the response message according to the number of accumulated received ACK messages, the number of accumulated received NACK messages, the first score, and the second score when receiving the response message is represented by
$$( \frac{{N}_{ACK}}{{N}_{TOTAL}} ) \times S\_ACK + ( \frac{{N}_{NACK}}{{N}_{TOTAL}} ) \times S\_NACK = {SNR}_{P} ,$$
where N_{ACK} is the number of accumulated received ACK messages, N_{NACK} is the number of accumulated received NACK messages, N_{TOTAL} is a sum of N_{ACK} and N_{NACK}, S_ACK is the first score, S_NACK is the second score, and SNR_{P} is the pseudo-SNR corresponding to the response message.

12. The method of claim 9, wherein the step of examining the eligibility of the modulation and coding scheme in use according to the pseudo-SNR corresponding to the response message comprises:
determining that the modulation and coding scheme in use can be used continuously when the pseudo-SNR corresponding to the response message is within the range of pseudo-SNR.

13. The method of claim 9, wherein the step of examining the eligibility of the modulation and coding scheme in use according to the pseudo-SNR corresponding to the response message comprises:
determining to update the modulation and coding scheme when the pseudo-SNR corresponding to the response message is out of the range of pseudo-SNR.

14. The method of claim 9, wherein the pseudo-SNR is an indication of channel condition.
